(19) United States
(12) Patent Application Publication
(10) Pub. No.: US 2010/0112267 A1
(43) Pub. Date: May 6, 2010

(54) Method for Injection Molding of Thermoplastic Polymer Material with Continuous Property Transitions

(75) Inventors: Holger Stenzel, Hennef (DE); Joachim Schnieders, Hoerstel (DE); Helmut Ridder, Delbrueck (DE)

Correspondence Address: MILLEN, WHITE, ZELANO & BRANIGAN, P.C., 2200 CLARENDON BLVD., SUITE 1400, ARLINGTON, VA, 22201, US

(73) Assignee: KURARAY EUROPE GMBH, Frankfurt (DE)

(21) Appl. No.: 12/610,532

(22) Filed: Nov. 2, 2009

(30) Foreign Application Priority Data
Nov. 3, 2008 (DE) 102008043393

(51) Int. Cl. B32B 5/14; B29C 45/16

(52) U.S. Cl. 428/60; 264/245

(57) ABSTRACT

The invention relates to a method for producing molded pieces with at least one continuous transition of physical and/or chemical properties by injection molding of thermoplastic polymer material wherein the continuous transition of the physical and/or chemical properties of the molded article is produced by modifying the portions of at least two melt streams, each with different physical and/or chemical properties, of the thermoplastic polymer material continuously and in opposite directions. Preferred produced molded articles can be films, in particular films suitable as interlayer for automotive laminated glass, and three-dimensional to components and molded articles.

### SUMMARY OF THE INVENTION

The invention relates to a method for producing molded pieces such as films with at least one continuous transition of physical and/or chemical properties by injection molding of thermoplastic polymer material of at least two melt streams.

Methods for injection molding of thermoplastic material having different colors or other properties, i.e. with a property transition in the molded article, are known. For example, U.S. Pat. No. 5,989,003; U.S. Pat. No. 3,061,879; U.S. Pat. No. 3,947,177 or WO 82/1160 describe injection molding methods wherein melt streams of different color or composition are injected into the injection mold in different arrangement with respect to time or space, and thus lead to molded articles with sections of different coloring or composition. However, the methods described here only allow for the production of molded articles with a discontinuous, i.e. abrupt, property transition such as for example from one coloring to another.

From another technical field, the continuous film extrusion, it is known to bring together several polymeric melt streams of different coloring in appropriately designed molds in such a way that in a selected section of the film a continuous transition from one color to another is obtained.

For example, interlayer films for automobile windshields with a so-called tinted band, i.e. with tinted and untinted sections, are produced by continuous extrusion methods. FIG. 1 shows such a film, with (A) designating a tinted section and (B) designating an untinted section. Typically, the top part of the film has a tinted section of a width of about 5-90 cm, preferably 10-25 cm, with the remainder of the film being of a different tint or untinted.

As an alternative to continuous film extrusion, in German Patent DE 10 2007 021103 Al a method is described to produce a sheet directly by means of the injection molding or injection-compression molding technique. The exterior dimensions of this sheet can be matched to the geometry of the windshield either exactly or optionally with a pre-defined projecting length, and hence the sheet can be laminated directly between two glass panels without additional treatment.

WO 2008/24805A1 and French Patent FR 2750075 describe injection molding methods of a different kind wherein a thermoplastic polymer material is directly injected between two glass panels to produce laminated safety glass.

In the production of windshields with a tinted band, an abrupt color transition is not desirable, but emphasis is put on a continuous color transition. This cannot be accomplished with the described injection molding methods.

Furthermore, only finished glass laminates can be produced by this method but not o individual films that are processed later on.

The production of molded pieces with continuous property changes by means of injection molding would also be advantageous for other applications. For example, hard/soft transitions, for example for damping elements, could be produced by suitable selection of the mechanical properties, without an abrupt change of the mechanical properties resulting in breaking points.

In addition, floats with continuously modified density distribution can be produced. For the production of components or molded articles, continuous color transitions can be used to conceal joints (welded seams, riveted joints). At present, these color transitions exist only discontinuously. In the area of tail light manufacturing, lenses can have continuous color transitions to produce lighting effects. This applies analogously to the consumer products industry, such as for example light-guiding faceplates of car radios, stereo equipment, etc. In addition, these transitions can be used for TV faceplates for the continuously modified transmission of the backlight (AMBILIGHT®). Further advantages can be expected from the use of optical waveguides and plastic fiber-optic rods used for the automotive industry (headlights, turn signals, tail lights) since color transitions in the fiber-optic light guide components can be produced that way, which until now could not be realized.

It is therefore an aspect of the present invention is to provide an injection molding method for molded pieces, with the help of which continuous property transitions for molded pieces without noticeable stages are made possible.

### BRIEF DESCRIPTION OF THE DRAWINGS

The invention and further details, such as features and attendant advantages, of the invention are explained in more detail below on the basis of exemplary embodiments which are diagrammatically depicted in the drawing, and wherein:

FIG. 1 shows a film with a tinted band produced by a continuous extrusion method;

FIG. 2 illustrates a thickness profile of a film in a side view produced by coextrusion wherein a continuous layer thickness progression of the colored layer from 0 to the required constant predetermined colored layer thickness occurs over a length determined by the adapter(s) of the coextrusion die;

FIG. 3 illustrates a top view of the film of FIG. 2;

FIG. 4 illustrates a device suitable for producing films in accordance with the invention wherein at least two injection units are used analogously to 2C injection molding;

FIGS. 5a and 5b illustrate side views of possible thickness profiles of films produced according to the invention;

FIG. 6 schematically illustrates a possible time course of the injection process according to the invention for preparing films with a continuous color transition; and

FIG. 7 shows cross-sections of wedge-shaped films in accordance with the invention.

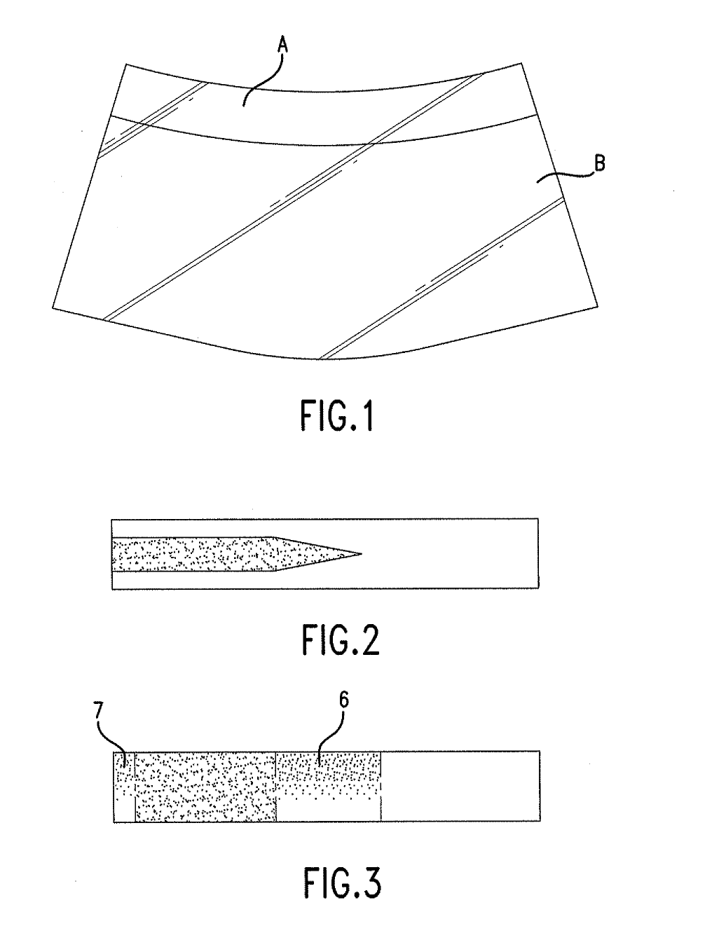

Subject matter of the present invention therefore includes a method for producing molded pieces with at least one continuous transition of physical and/or chemical properties by injection molding of thermoplastic polymer material wherein the continuous transitions of the physical and/or chemical properties of the molded article are produced by modifying the respective portions of at least two melt streams of thermoplastic polymer material, each with different physical and/or chemical properties, in opposite directions. For example, the portion of a melt stream containing a colorant increased while at the same time the portion of another melt stream containing no colorant (or a lower amount of colorant or a colorant having a different color)) is decreased.

The following explanations for injection molding apply analogously to injection-compression molding. Furthermore, the explanations for producing continuous color transitions apply analogously to the continuous change of each physical and/or chemical property of the molded article resulting from the use of at least two melt streams, each comprising for example different polymers, plasticizers, colors, additives and/or filler and reinforcing materials. See, for example, the different polymers, plasticizers, and filers described below.

All addition agents amounting to a portion of less than 10% by weight of the respective melt stream are referred to as additive. Organic or inorganic color pigments also fall under this category.

All addition agents amounting to a portion of more than 10% by weight of the respective melt stream are referred to as filler and reinforcing materials. For example, such materials can be: glass fibers, glass spheres, talcum powder, and/or electrically conducting materials (carbon black, low-melting metal alloys, and/or metal fibers).

Within the scope of the present invention, a property transition that occurs in at least 0.5%, preferably 1%, more preferably 5% and most preferably 10%, 20% or 50% of the length of the molded piece is referred to as continuous property transition. In an extreme case, the property transition occurs over the whole length of the molded piece.

One embodiment of the method according to the invention is modeled on a variant of the common injection molding method, the two-component injection molding method—called 2C method for brevity.

In the 2C method, there are different types of injection molding, which have in common that injection molding machines having two injection units but only one clamping unit are required. The injection units have to work in a harmonizing manner but must always be controllable independent of each other. The components can be injected through a special nozzle or introduced into the mold at different points.

In the extrusion of interlayer films for windshields, at present the tinted band is realized by coextrusion, i.e. by extruding a colored layer onto a transparent layer or extruding it in-between two transparent layers. The optical impression of the transition between the colored and the transparent section is here of particular importance. To generate an optically pleasing tinted band, the transition between transparent and colored section is not sharply defined but is fluent (continuous) without visible shades. It is therefore referred to as fade-out section.

In the coextrusion of films according to the state of the art this is realized in such a manner that the adapter distributing the colored melt is designed geometrically in such a way that a continuous layer thickness progression of the colored layer from 0 to the required constant predetermined colored layer thickness occurs over a length given by the adapter.

FIG. 2 shows a possible thickness profile of such a film in a side view. The degree of dyeing of the colored layer is constant and the fade out (corresponding top view in FIG. 3) is realized by a variable layer thickness of the colored layer. The color gradient can be changed by means of differently shaped color distribution adapters in the coextrusion die.

Until now, application of this method in the injection molding and injection-compression molding process has not been possible since layers ending in a thickness of 0 cannot be realized by methods in accordance with the state of the art, even if optimized flowability of the raw material used and tempered mold cavities are taken into account. In the 2C injection molding process according to the state of the art, one obtains a more or less sharp, i.e. discontinuous, differentiation of the components from one another. An optically sharply defined separation of transparent section and tinted band, however, is not desirable in films for automotive windshields.

The method according to the invention therefore provides for a different approach: The color transition is realized by continuously increasing the degree of dyeing of the injected material in the fade-out section while the thickness of the colored layer remains constant. FIG. 3 shows the top view of such a color gradient, with (6) designating the fade-out section and (7) designating a discontinuous color transition from colored to colorless. The section between (7) and (6) is characterized by a constant color depth and is frequently referred to as dark plateau. FIGS. 5a and b show possible thickness profiles of films produced according to the invention as side view.

In the method according to the invention, the continuous transition of the physical and/or chemical properties of the molded article can be produced by mixing at least two melt streams, each having different chemical and/or physical properties. Mixing of the at least two melt streams can take place in the injection mold, but also by bringing the melt streams together and mixing them prior to the injection mold in a static or dynamic mixer.

The property transition(s), in particular color transitions, in the molded article can be achieved by increasing the portion of one (e.g. the dyed) melt stream and, contrary to this, decreasing the portion of the other (e.g. the colorless) melt stream. Preferably, modification of the portions takes place continuously.

In a further variant of the method, the continuous transition of the physical and/or chemical properties of the molded article can be produced by modifying the thickness of layers of at least two melt streams, each having different chemical and/or physical properties, in opposite directions in the molded article.

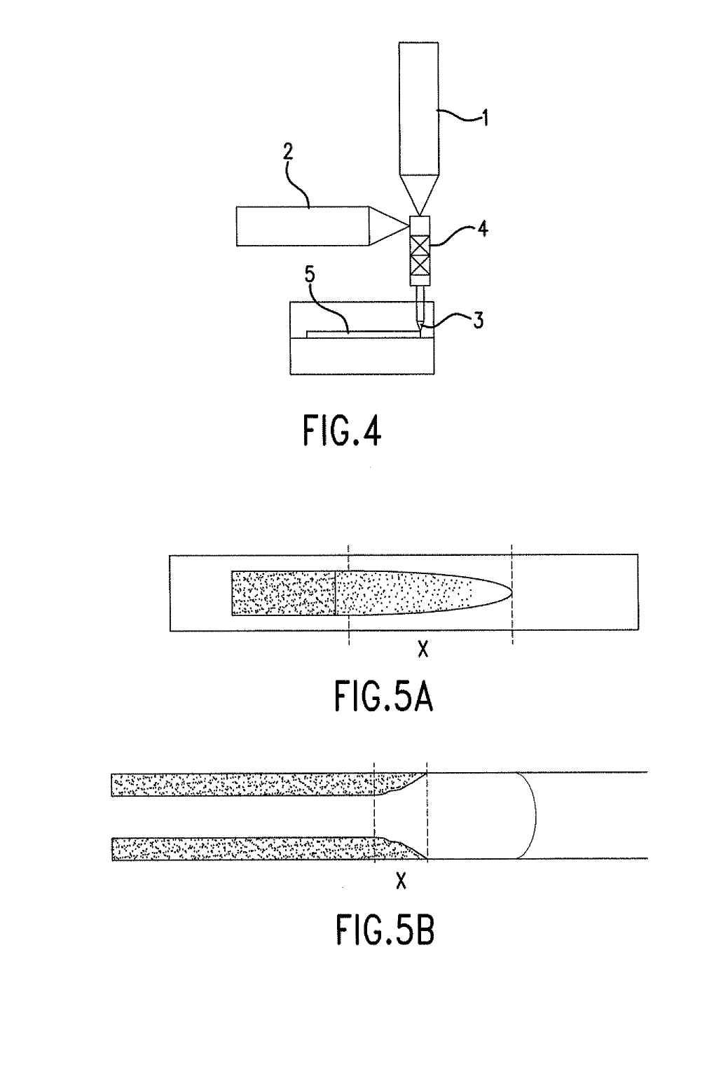

Here, a first one layer is produced in the injection mold by a first melt stream. Then, the portion of the first melt stream is reduced and, in turn, the portion of the second melt stream is increased. Here, modification of the thickness of the layers also preferably occurs continuously. Hereby, a multi-layer system form in a transition section, which macroscopically exhibits a property or color mixture of the two layers or melt streams. FIGS. 5a and b show a schematic representation of a cross-section of a molded article produced according to the invention, with x representing the transition section. Thus, for example, the melt stream for the inner layer in FIG. 5a (the top drawing in FIG. 5) can be prepared by the using the units (1) and (2) and mixer (4) of the embodiment shown in FIG. 4, discussed below, and the inner and outer layers can be coextruded.

Each of the melt streams used in the method according to the invention can have the same composition except for different colors, additives and/or filler and reinforcing materials. In the simplest case, each of the melt streams has the same composition except for different colors, filler and reinforcing materials or additives, and at least one of the melt streams is colorless or is devoid of the filler and reinforcing material or the additive.

By means of the method according to the invention, molded articles with one or more property or color transitions can be produced. Preferably, the molded articles produced according to the invention only have one continuous property or color transition. For the production of films for laminated glass, the films exhibit in particular a continuous color transition from a colored to a colorless, i.e. transparent, section. For this, it is necessary that at least one of the melt streams is colorless and the other is appropriately dyed.

The property or color transition can be complete, i.e. the portions of the at least two melt streams, each having different physical and/or chemical properties, are modified in opposite directions, in particular continuously, from 0% and 100% of the thermoplastic polymer material for one of the melts streams, and from to 100% and 0% of the thermoplastic polymer material for another of the melt streams.

It is also possible to not completely carry through the property or color transition, i.e. the respective portions of the melt streams, each having different physical and/or chemical properties, are in the section with the biggest property or color difference complementary for example 10 to 90, 20 to 80, 30 to 70, 40 to 60 or 50 to 50% as well.

In case of the production of films for laminated glass according to the invention, this can be utilized for example to keep the melt stream with the colored material as small as possible with respect to volume, i.e. to use a strongly dyed master batch as colored melt stream with a colorless melt stream. Hereby, the exact coloring of the tinted band is achieved by controlling the injection process and not by blending the colored melt stream.

In a special variant of the method, the melt streams have the same composition except for different colors or additives; in particular at least one of the melt streams is colorless or is without additive. In this case, in the section of constant color depth, the so-called dark plateau, only constantly dyed melt would be injected. At best, the entire film thickness is utilized for dyeing.

In the method according to the invention, at least two injection units are used analogously to 2C injection molding. FIG. 4 shows schematically a device suitable for the method according to the invention. In the first plasticizing unit (1), a transparent melt is provided; in the second unit (2), a dyed melt is provided. The degree of dyeing is adjusted in such a way that the film subsequently has in the deeply dyed section, the so-called dark plateau, exactly the required degree of dyeing or required light transmission.

The injection process for the tinted band section occurs via a film sprue (3) at the film side to be applied to the top edge of the windshield perpendicular to the running of the tinted band. This ensures that the flow front runs parallel to the top edge of the film in the cavity. The two plasticizing units are connected to the cavity (5) via a static mixing element (4).

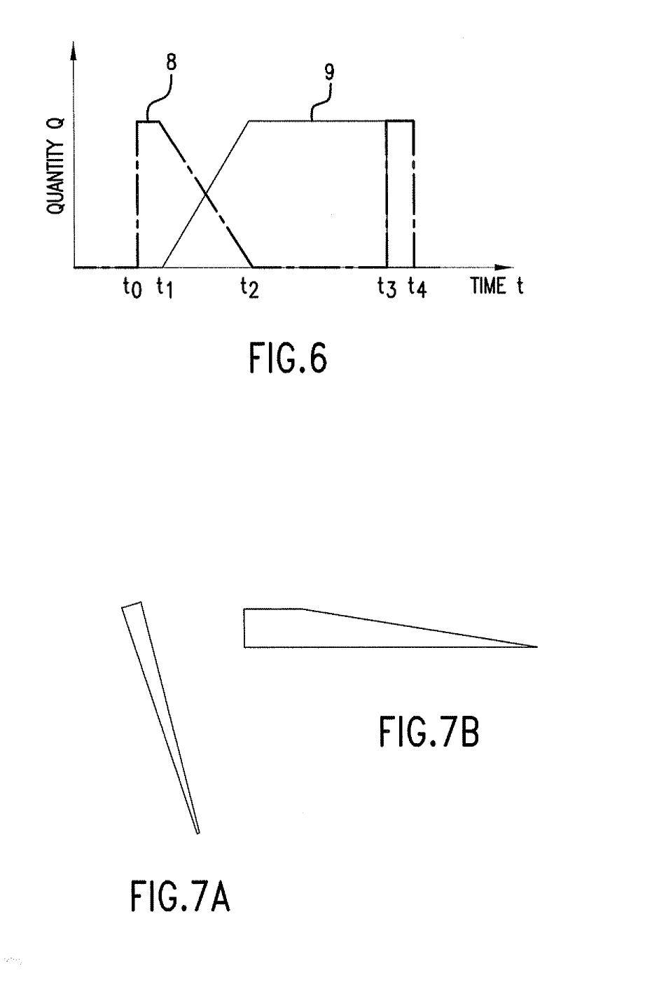

A possible time course of the injection process according to the invention is represented schematically for continuous color transitions in FIG. 6. At the beginning of the injection process t₀, initially only transparent melt (8) is injected. From a defined time t₁ on, colored melt (9) is additionally injected, which is for example locally homogeneously mixed via the static mixer with the transparent melt. From time t₁ on, the injection of colored melt is started, the quantity of colored melt (9) being continuously increased and, contrary to this, the quantity of transparent melt (8) being reduced by e.g. the same absolute amount. The modification of the quantities can occur in a program-controlled manner to set a pre-defined color gradient.

If in the cavity the melt front has traveled forward a distance corresponding to the length of the fade out (6), the transparent melt (8) is completely cut off and only colored melt (9) is injected (t₂). Since the distance traveled by the melt front in the cavity corresponds to a defined time period, control of the two injection units normally takes place in a time-controlled manner.

Shortly before the cavity is filled, it can be switched back completely to the transparent melt (8) without or largely without transition, i.e. discontinuously, so that the next injection process can begin again with transparent melt (8).

The method according to the invention can be performed in such a way that the molded article exhibits after a completed continuous transition of physical and/or chemical properties a largely discontinuous transition of physical and/or chemical properties.

In case of a color transition, a continuous color transition can therefore be followed by a discontinuous or at least largely discontinuous color transition (see FIG. 3, section 7).

Discontinuous property transition means those transitions that, based on the length of the molded piece, occur in a shorter segment than the described segments for continuous transitions. For example, in the production of a sheet, a fade out at top edge thereof is not desirable but the film edge typically ends with a dark plateau. The change-over from colored to transparent must therefore occur in the shortest time possible. In the example of the injection process depicted in FIG. 6, for this purpose the injection of colored material (9) is stopped at a defined time t₃ while simultaneously transparent melt (8) is injected to 100%. A short, discontinuous color transition (7 in FIG. 3) at the top edge of the sheet is then formed, which, however, can be covered by the black screen printing edge typically present on the windshield.

In a special variant of the method, the melt streams having different chemical and/or physical properties such as for example different coloring are brought together and mixed in a static or dynamic mixer. Hereby, a homogeneous mixture without surface waviness is injected into the mold.

To achieve a property or color transition that is as stageless and continuous as possible, the melt streams, which each have different chemical and/or physical properties, must be mixed with one another as thoroughly as possible. This can occur for example in the injection mold itself or in the runner to the injection mold. In a special embodiment of the method according to the invention, the melt streams, each with different chemical and/or physical properties, are brought together and mixed in one or more static or dynamic mixers. Only the homogeneous mixture thus obtained is injected into the mold.

The design of the static mixing element (4 in FIG. 4), in which the melt streams are locally homogeneously mixed, is of particular importance here. The mixer has to be dimensioned in such a way that with sufficient mixing action it has the shortest dwell time distribution possible. At time t₄ of FIG. 6, the cavity is therefore completely filled, and the film can be cooled and subsequently removed from the mold.

The method according to the invention can be used in particular for the production of damping elements, floats, headlights, turn signals or tail lights in the automotive sector, light-guiding faceplates for the consumer products industry, for example for car radios, stereo equipment or TV faceplates.

A further subject matter of the invention is films made by the method according to the invention for the production of laminated glass. The films preferably exhibit a color transition from a transparent to a colored section. As an alternative or in addition to the property or color transition, the films can have a wedge-shaped thickness profile or cross-section.

Films produced according to the invention can have a wedge-shaped cross-section corresponding to an angle of 0.1 to 1 mrad, preferably 0.3 to 0.7 mrad and in particular 0.4 to 0.6 mrad. FIG. 7 shows possible cross-sections of such films.

Wedge-shaped films are used for the projection in head-up displays and are described for example in EP 0 893 726 B1. In a projection onto laminated glass consisting of two glass panels connected by means of a PVB film, annoying ghost images are typically generated. This negative effect is prevented by the films being designed in a wedge shape for a few arc minutes and both images then being on top of each other.

By means of the injection molding or injection-compression molding technique according to the invention, nearly any progression of the film thickness can be created. The exterior dimensions of the produced sheet can be matched to the geometry of the windshield either exactly or optionally with a pre-defined projecting length.

In the method according to the invention, thermoplastic polymer melts are used for the production of films, semi-finished products and/or finished products. For example, each of the melt streams can comprise, identically or differently, one or more polymers selected from the group of polyolefins and special types and blends thereof, polystyrenes and styrene copolymers, polymethyl methacrylate, polyacrylonitrile, polyvinyl acetals, fluoro- and chloropolymers, polyamides, polycarbonates, polyethylene and polybutylene terephthalates, polyphenylene oxide, polysulfone and derivatives thereof, polyketones. Each of the melt streams containing these polymers can be identical or different and/or have added colors or additives and filler and reinforcing materials or plasticizers.

In the method according to the invention, in particular in the production of films for laminated glass production, each of the melt streams can comprise, identically or differently and/or with added colors, additives or plasticizers, plasticizer-containing polyvinyl acetal, plasticizer-containing polyvinyl alcohol, plasticizer-containing vinyl alcohol/vinyl acetate/ethylene copolymer, plasticizer-containing partially acetalized vinyl alcohol/vinyl acetate/ethylene copolymer.

EXEVAL® or EVAL® of Kuraray Co. (Japan) in particular can be used as vinyl alcohol/vinyl acetate/ethylene terpolymers. As plasticizer for polyvinyl alcohol and vinyl alcohol/vinyl acetate/ethylene copolymer, for example water or glycerin can be used.

The polyvinyl acetals or partially acetalized vinyl alcohol/vinyl acetate/ethylene copolymers have, besides non-saponified acetate groups, hydroxyl groups, which are bonded to the polymer backbone and fully or partially acetalized with one or more aldehydes. The production of polyvinyl acetals for use in accordance with the invention is known to those skilled in the art.

For production of the polyvinyl acetals of the partially acetalized vinyl alcohol/vinyl acetate/ethylene copolymers, preferably one or more aldehydes having 1 to 10 carbon atoms such as for example formaldehyde, acetaldehyde, propionaldehyde, butyraldehyde or octanal are used. Butyraldehyde, which leads to the known polyvinyl butyral (PVB), is particularly preferred. Suitable polyvinyl butyrals have a residual vinyl alcohol content in accordance with ASTM D 1396 of 16 to 25% by weight, in particular 16 to 20% by weight, and are described for example in WO 03/051974 A1 or EP 1 412 178 B1. The materials used according to the invention are produced by adding suitable plasticizers to polyvinyl acetals. Alternatively, the use of internally plasticized polyvinyl acetals, i.e. polyvinyl acetals having suitable, covalently bonded side chains, is also possible.

It is also possible to use polyvinyl butyrals cross-linked with dialdehydes or aldehyde-carboxylic acids. Suitable polymers of this type are described for example in German Patent DE 10 143 109 A1 or WO 02/40578 A1.

The melt streams or thermoplastic molding compounds used according to the invention typically comprise 10-40% by weight of one or more plasticizers.

As plasticizer for the polyvinyl acetal, the known “standard plasticizers” for the production of laminated glass such as diethylene glycol di-2-ethyl hexanoate, triethylene glycol di-2-ethyl butyrate (3GH), triethylene glycol di-n-hexanoate (3G6), triethylene glycol di-n-heptanoate (3G7), triethylene glycol di-2-ethyl hexanoate, triethylene glycol octanoate, tetraethylene glycol di-2-ethyl hexanoate (3G8), dihexyl adipate (DAH), dialkyl adipates with an alkyl radical having more than 6 carbon atoms, and oligoglycolic acid esters with a carboxylic acid radical having more than 7 carbon atoms, in particular dioctyl adipate (DOA), etc. can be used.

Either alone or in a mixture with the standard plasticizers, plasticizers selected from the following group of di(2-butoxyethyl)adipate (DBEA), di(2-butoxyethyl)sebacate (DBES), di(2-butoxyethyl)azelate, di(2-butoxyethyl)glutarate, di(2-butoxyethoxyethyl)adipate (DBEEA), di(2-butoxyethoxyethyl)sebacate (DBEES), di(2-butoxyethoxyethyl)azelate, di(2-butoxyethoxyethyl)glutarate, di(2-hexoxyethyl)adipate, di(2-hexoxyethyl)sebacate, di(2-hexoxyethyl)azelate, di(2-hexoxyethyl)glutarate, di(2-hexoxyethoxyethyl)adipate, di(2-hexoxyethoxyethyl)sebacate, di(2-hexoxyethoxyethyl)azelate, di(2-hexoxyethoxyethyl)glutarate, di(2-butoxyethyl)phthalate, di(2-butoxyethoxyethyl)phthalate and/or cyclohexane dicarboxylic acid diisononyl ester (DINCH) can be used.

Films produced according to the invention can comprise further additives known to those skilled in the art such as residual amounts of water, UV absorber, antioxidants, adhesion regulators (e.g. potassium and/or magnesium salts), optical brighteners, stabilizers, colorants, processing aids and/or surface-active substances. Systems of this type are described for example in EP 0 185 863 A1, WO 03/097347 A1 or WO 01/43963 A1.

Processing of the films according to the invention to laminated safety glass can occur as customary in the laminated glass production, for example, by vacuum bag methods or pre-laminate/autoclave processes. Here, the film is placed between two glass panels, and the trapped air is largely removed by applying a vacuum or external pressure. The pre-laminate thus obtained can subsequently be pressed to transparent laminated glass in an autoclave under elevated pressure and an elevated temperature.

Alternatively, single-stage processes can also be performed, in which an assembled glass/film laminate is pressed under vacuum action and processed to transparent bubble-free laminated glass at elevated temperatures (about 100-150° C.).

Interlayer films having a uniform thickness profile are one-sidedly stretched by the manufacturer of windshields in order to allow the tinted band to run parallel to the top edge of the windshield, which normally is not rectangular. By the stretching process, the thickness profile of the film is also modified, which in particular with films having a wedge-shaped cross-section can have a negative impact on the wedge profile.

With films produced according to the invention having a wedge-shaped thickness profile or cross-section, the described stretching process of the film is omitted since these films already have the required shape. Films of this type are suitable in particular for head-up display applications.

Without further elaboration, it is believed that one skilled in the art can, using the preceding description, utilize the present invention to its fullest extent. The preceding preferred specific embodiments are, therefore, to be construed as merely illustrative, and not limitative of the remainder of the disclosure in any way whatsoever.

The entire disclosures of all applications, patents and publications, cited herein and of corresponding German application No. 102008043393, filed Nov. 3, 2008.

From the foregoing description, one skilled in the art can easily ascertain the essential characteristics of this invention and, without departing from the spirit and scope thereof, can make various changes and modifications of the invention to adapt it to various usages and conditions.

1. A method for producing molded pieces with at least one continuous transition of physical and/or chemical properties comprising:
subjecting at least two melt streams of thermoplastic polymer material to injection molding, wherein at least two of said melt streams have different physical and/or chemical properties;
forming a continuous transition of at least one physical property and/or at least one chemical property of the molded article by modifying the respective portions of said at least two melt streams of thermoplastic polymer material, each with different physical and/or chemical properties, in opposite directions.

2. A method according to claim 1, wherein said continuous transition of the at least one physical property and/or at least one chemical property of the molded article is produced by mixing said at least two melt streams of thermoplastic polymer material.

3. A method according to claim 2, wherein mixing of the at least two melt streams of thermoplastic polymer material occurs in an injection mold.

4. A method according to claim 2, wherein the at least two melt streams of thermoplastic polymer material are brought together and mixed, prior to introduction into an injection mold, in a static or dynamic mixer.

5. A method according to claim 1, wherein said continuous transition of the at least one physical property and/or at least one chemical property of the molded article is produced by modifying the thickness of layers of the at least two melt streams of thermoplastic polymer material in the molded article in opposite directions.

6. A method according to claim 1, wherein the portions of the at least two melt streams of thermoplastic polymer material, which each have different physical and/or chemical properties, are modified in opposite directions from 0% and 100% of the thermoplastic polymer material to 100% and 0%, respectively, of the thermoplastic material.

7. A method according to claim 1, wherein the molded article exhibits, after a completed continuous transition of the at least one physical property and/or at least one chemical property, a largely discontinuous transition of said at least one physical property and/or at least one chemical property.

8. A method according to claim 1, wherein said two melt streams comprises different polymers, plasticizers, colors, additives, fillers, and/or reinforcing materials.

9. A method according to claim 1, wherein each of said at least two melt streams comprises different polymers, plasticizers, colors, additives, fillers, and/or reinforcing materials.

10. A method according to claim 1, wherein said two melt streams has the same composition except for different colors, additives, fillers, and/or reinforcing materials.

11. A method according to claim 1, wherein each of said at least two melt streams has the same composition except for different colors, additives, fillers, and/or reinforcing materials.

12. A method according to claim 1, wherein said two melt streams has the same composition except for different colors, additives, filler, and/or reinforcing materials, and at least one of the melt stream is colorless.

13. A method according to claim 1, wherein each of said at least two melt streams has the same composition except for different colors, additives, filler, and/or reinforcing materials, and at least one of the melt stream is colorless.

14. A method according to claim 1, wherein said two melt streams comprises, identically or differently, one or more polymers selected from the group of polyolefins and special types and blends thereof, polystyrenes and styrene copolymers, polymethyl methacrylate, polyacrylonitrile, polyvinyl acetals, fluoro- and chloropolymers, polyamides, polycarbonates, polyethylene and polybutylene terephthalates, polyphenylene oxide, polysulfone and derivatives thereof, and polyketones.

15. (canceled)

16. A film for producing laminated glass produced by a method according to claim 1.

17. A film according to claim 16, wherein said film exhibits a continuous color transition from a transparent section to a colored section.

18. A film according to claim 16, wherein said film exhibits a wedge-shaped thickness profile.

19. A three-dimensional component or molded article produced by a method according to claim 1.

20. A three-dimensional component or molded article according to claim 19, wherein said three-dimensional component or molded article exhibits a continuous color transition from a transparent section to a colored section.

21. A three-dimensional component or molded article according to claim 19, wherein said three-dimensional component or molded article exhibits a continuous transition from a hard section to a soft section.
